(19) United States
(12) Patent Application Publication
(10) Pub. No.: US 2018/0101793 A1
(43) Pub. Date: Apr. 12, 2018

(54) MOBILE DEVICE ROOM SELECTION

(71) Applicant: Agilysys, Inc., Alpharetta, GA (US)

(72) Inventor: Larry Steinberg, Sammamish, WA (US)

(21) Appl. No.: 15/726,694

(22) Filed: Oct. 6, 2017

Related U.S. Application Data
(60) Provisional application No. 62/405,130, filed on Oct. 6, 2016.

(51) Int. Cl. G06Q 10/02; G06F 17/30; H04L 29/08; H04L 9/32; G06F 9/44

(52) U.S. Cl. CPC G06Q 10/02; G06F 17/30867; G06F 9/4443; H04L 9/32; H04L 67/306

(57) ABSTRACT

A system and method that allow a customer of a hotel property to search and book a room using the customer's mobile device is disclosed. The system provides a search interface that enables the mobile device user to enter a search query. Using the received search query, information regarding attributes and preferences of a desired hotel property, and/or information regarding attributes of individual rooms located within the desired hotel property, the system computes a match score for each available room that is indicative of a degree to which the room matches certain search criteria, attributes, and preferences. As a result, the system identifies matching rooms that are better suited to the preferences of the mobile device user as well to the preferences of hotel property agents or administrators. The system presents the identified matching rooms to the mobile device user. In some embodiments, the system displays matching rooms in a manner that allows the mobile device user to readily gauge the relative strength of each matching room. The mobile device user may select a room from the presented matches and complete a booking of the selected room. After booking, the system may update attributes or preferences related to the mobile device user, the booked room, and/or the hotel property in which the booked room is located.

### CROSS-REFERENCE TO RELATED APPLICATION(S)

This application claims the benefit of U.S. Provisional Patent Application No. 62/405,130 filed on Oct. 6, 2016, entitled MOBILE DEVICE ROOM SELECTION, which is incorporated herein by reference in its entirety.

### BACKGROUND

When searching for a hotel room, customers using a mobile device often are concerned with selecting the best suited hotel room as quickly and easily as possible. Too often, however, mobile device customers are inundated with a large number of search results that prohibit them from selecting the best hotel room with the speed and convenience desired. The large number of results returned from a typical hotel room search is time consuming for customers to sort through, and the process can be particularly difficult when viewing search results on a relatively small screen found on a typical mobile device. Moreover, in a typical hotel room search, the significant percentage of search results that do not interest the customer further frustrates the search process by consuming valuable time unnecessarily. Adding yet more frustration, customers often find it necessary to sift through hotel room search results for which they are not actually eligible to book for one or more reasons. For example, a customer may waste time reviewing ocean view suites in a set of search results only to later discover that he or she may not book any ocean view suites due to a lack of loyalty or VIP status.

These deficiencies present challenges for hotel property operators as well. Mobile device customers who are not able to quickly and easily complete a booking via a mobile device may be more likely to call hotel property staff directly, thereby increasing administrative costs associated with hotel bookings. Moreover, such calls may place hotel operators in the uncomfortable and time consuming position of having to explain and justify hotel booking policies to frustrated customers.

There is therefore a need for a better method of mobile device room selection that address these and other problems that exist in current systems.

### BRIEF DESCRIPTION OF THE DRAWINGS

FIG. 1 is a block diagram illustrating a representative environment 100 in which a mobile device room selection system 130 operates.

FIG. 2 is an exemplary block diagram illustrating an embodiment of the elements of the system of FIG. 1 in more detail.

FIG. 3A is a graphical depiction of a background portion of an example customer profile in accordance with embodiments disclosed herein.

FIG. 3B is a graphical depiction of a preferences portion of an example customer profile in accordance with embodiments disclosed herein.

FIG. 4 is a graphical depiction of an example hotel property profile in accordance with embodiments disclosed herein.

FIG. 5 is a graphical depiction of an example room profile in accordance with embodiments disclosed herein.

FIG. 6 is a flowchart showing a method implemented by the mobile device room selection system to enable a customer to search for and book a room in accordance with embodiments herein.

FIG. 7A is a graphical depiction of an example customer login screen in accordance with embodiments disclosed herein.

FIG. 7B is a graphical depiction of an example customer welcome screen in accordance with embodiments disclosed herein.

FIG. 8 is a graphical depiction of an example search interface screen in accordance with embodiments disclosed herein.

FIG. 9 is a flowchart showing a method implemented by the mobile device room selection system to run a search/matching algorithm in accordance with embodiments herein.

FIG. 10A is a graphical depiction of a first embodiment of a search results interface as disclosed herein.

FIG. 10B is a graphical depiction of a second embodiment of a search results interface as disclosed herein.

### DETAILED DESCRIPTION

A system and method that allow a customer of a hotel property to search and book a hotel room via the customer's mobile device is disclosed. The system allows the customer to validate credentials to log in to the system, allows the customer to formulate a search query for locating available rooms, and then identifies available rooms that match the customer's search query as well as other customer preferences and hotel property preferences.

The system tracks customer preferences and hotel property preferences in one or more profiles that are maintained by the system. For example, the system maintains multiple customer profiles that each correspond to an individual customer of the hotel property. A customer profile contains information that is viewable and editable by the customer, such as the customer's preferences regarding proximity to hotel property amenities, or the customer's preferences regarding handicap accessibility or the availability of room service. In addition, a customer profile may contain information that is not viewable by the customer (such as manual notes entered by an agent or administrator of a hotel property) and may contain information that is viewable but not editable by the customer (such as a loyalty status level or point balance). The system also maintains a hotel property profile that contains information that applies to the hotel property as a whole, such as the presence of certain amenities (such as a concierge, restaurant, airport shuttle), or an indication of certain preferences regarding the operation or administration of the hotel property (such as dispersion preferences that govern a manner in which rooms are allocated throughout the hotel property). The system also maintains multiple room profiles, each corresponding to an individual room located within the hotel property. A room profile may contain information on a per-room basis about a particular room's amenities (such as an ocean view, a coffee maker, or a king size bed). A customer may view certain information contained in hotel property profiles and individual room profiles (such as a list of amenities or available scenic views), but may not view certain confidential information contained in hotel property profiles and individual room profiles (such as dispersion preferences). Typically, information in a hotel property profile or room profile may be edited by an agent or administrator of a hotel property and not directly by a customer. In addition, the mobile device selection system may make automatic edits and updates to hotel property profiles, room profiles, and customer profiles. Such automatic edits and updates may occur, for example, when a customer completes a booking of a room, or when a time-dependent preference (such as a dispersion preference) commences or expires.

In one embodiment, in order to identify rooms in response to a customer's search query, the system determines which rooms are available (i.e., which rooms are not already booked) during the requested time period. The system then eliminates available rooms that conflict with certain hotel property preferences or customer preferences. For the remaining rooms, the system identifies those rooms that satisfy one or more hotel property preferences and also satisfy one or more customer preferences. Rooms satisfying one or more hotel property preferences and one or more customer preferences are designated as matching rooms to be presented to the customer for possible selection and booking.

The system presents the matching rooms to the customer in an interface that graphically depicts the matching rooms in relation to the layout of the hotel property and amenities of the hotel property. Accordingly, a customer has the ability to readily ascertain certain aspects of a presented matching room (such as a scenic view from the room, proximity to an elevator, etc.) before making a final room selection. In some embodiments, the system determines the strength of each matching room and presents each room in a fashion that enables the customer to distinguish among rooms that more strongly match the customer's preferences and those rooms that are weaker matches to the customer's preferences. For example, the system may display strong matches in a solid pattern while displaying weaker matches in a diagonal stripe or dotted pattern. In addition, the system presents enhanced information about a matching room that is selected (but not yet booked) by a customer, including an indication of one or more attributes of the selected room that match the customer's preferences and an indication of one or more attributes of the selected room that do not match the customer's preferences. Once the customer decides to book a room, the customer selects the desired room on the presented interface and proceeds to the booking process. After the customer books the selected room, the system may automatically update various profile information, including the customer's loyalty status and point balance, and the availability dates associated with the booked room.

Those skilled in the art will appreciate that the mobile device room selection system 130 may be implemented on any computing system or device. Suitable computing systems or devices include personal computers, server computers, hand-held or laptop devices, multiprocessor systems, microprocessor-based systems, programmable client electronics, network devices, minicomputers, mainframe computers, distributed computing environments that include any of the foregoing, and the like. Such computing systems or devices may include one or more processors that execute software to perform the functions described herein. Processors include programmable general-purpose or special-purpose microprocessors, programmable controllers, application specific integrated circuits (ASICs), programmable logic devices (PLDs), or the like, or a combination of such devices. Software may be stored in memory, such as random access memory (RAM), read-only memory (ROM), flash memory, or the like, or a combination of such components. Software may also be stored in one or more storage devices, such as magnetic or optical based disks, flash memory devices, or any other type of non-volatile storage medium for storing data. Software may include one or more program modules which include routines, programs, objects, components, data structures, and so on that perform particular tasks or implement particular abstract data types. The functionality of the program modules may be combined or distributed across multiple computing systems or devices as desired in various embodiments.

It will also be appreciated that the mobile device room selection system 130 includes multiple elements coupled to one another and each element is illustrated as being individual and distinct. However, in some embodiments, some or all of the components and functions represented by each of the elements can be combined in any convenient and/or known manner or divided over multiple components and/or processing units. For example, the elements of the mobile device room selection system 130 may be implemented on a single computer, multiple computers, and/or in a distributed fashion. As another example, certain elements, or portions thereof, may be stored in memory 235, may reside externally and/or be transferred between memory 235 and a persistent storage device 215 (e.g., hard drive) for purposes of memory management, data integrity, and/or other purposes. Furthermore, the functions represented by the components can be implemented individually or in any combination thereof, in hardware, software, or a combination of hardware and software. Different and additional hardware modules and/or software agents may be included in the mobile device room selection system 130 without deviating from the spirit of the disclosure.

The system and method can also be practiced in distributed computing environments, where tasks or modules are performed by remote processing devices, which are linked through a communications network, such as a Local Area Network (“LAN”), Wide Area Network (“WAN”), or the Internet. In a distributed computing environment, program modules or subroutines may be located in both local and remote memory storage devices. Aspects of the system described herein may be stored or distributed on tangible, non-transitory computer-readable media, including magnetic and optically readable and removable computer discs, stored in firmware in chips (e.g., EEPROM chips). Alternatively, aspects of the system may be distributed electronically over the Internet or over other networks (including wireless networks). Those skilled in the relevant art will recognize that portions of the system may reside on a server computer, while corresponding portions reside on a client computer.

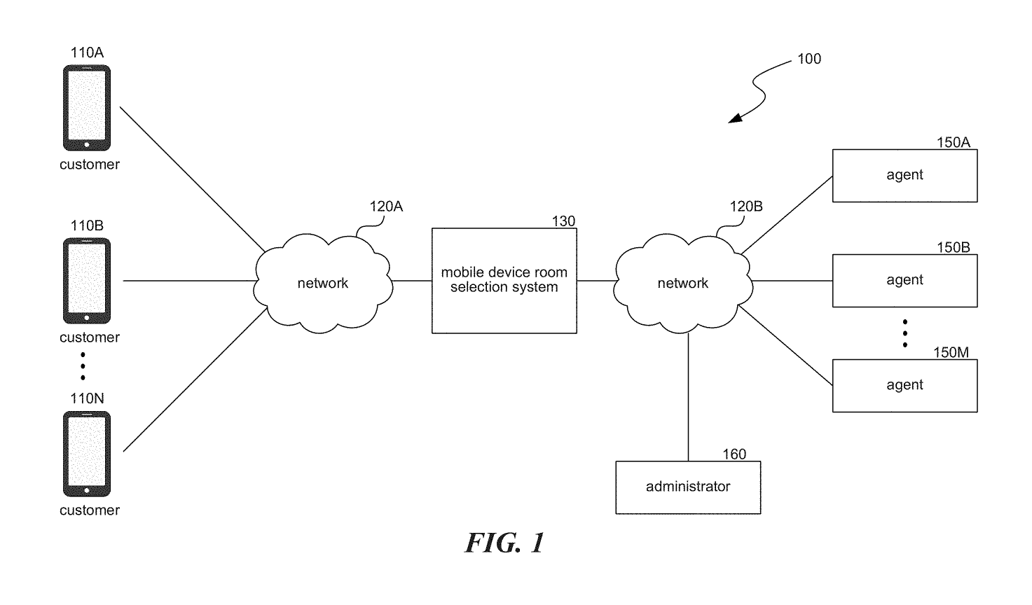

FIG. 1 is an exemplary block diagram illustrating an embodiment of a representative environment in which the mobile device room selection system 130 may operate. The environment 100 includes a plurality of customers 110A-110N, network portions 120A and 120B, a mobile device room selection system 130, a plurality of agents 150A-150M, and an administrator 160. The customers 110A-110N are coupled via the network portion 120A to the mobile device room selection system 130, which in turn is coupled through the network portion 120B to the plurality of agents 150A-150M and the administrator 160. As will be described in more detail below, the mobile device room selection system 130 identifies available rooms based on a customer search query, customer preferences, and hotel property preferences, and displays identified matching rooms to the customer for selection and booking.

The plurality of customers 110A-110N may include individual people, businesses, governmental agencies, or any other entities capable of inquiring about or booking a room. The plurality of agents 150A-150M may include hotel property staff, such a reservations agents or managers, who are authorized to assist with bookings, edit hotel property profile information or customer profile information, or access hotel property profile information or customer profile information that may or may not be viewable and/or editable by customers. The administrator 160 may include hotel property staff with the same viewing and editing privileges as agents 150A-150M, as well as additional permission to edit property profile information, including dispersion preferences. The mobile device room selection system 130 may include any system and/or device, and/or any combination of devices/systems that provide customers 110A-110N, agents 150A-150M, and administrator 160 to access the mobile device room selection system 130 via network portions 120A and 120B. The network portions 120A and 120B may include any public or private network, or any collection of distinct networks operating wholly or partially in conjunction to provide connectivity between the mobile device room selection system 130 and the customers 110A-110N, agents 150A-150M, and administrator 160, and may appear as one or more networks to the serviced parties, systems, and/or devices.

The network portions 120A and 120B may include, but are not limited to, a Voice over Internet Protocol (VoIP) network, a cellular telecommunications network, a public-switched telephone network (PSTN), any combination of these networks, or any other suitable network that can carry telecommunications. In one embodiment, communications over the network portions 120A and 120B may be achieved by a secure communications protocol, such as secure sockets layer (SSL), or transport layer security (TLS). In addition, communications can be achieved via one or more wireless networks, such as, but not limited to, one or more of a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), Global System for Mobile Communications (GSM), Personal Communications Service (PCS), Digital Advanced Mobile Phone Service (D-Amps), Bluetooth, Wi-Fi, Fixed Wireless Data, 2G, 2.5G, 3G, 4G networks, enhanced data rates for GSM evolution (EDGE), General packet radio service (GPRS), enhanced GPRS, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks or messaging protocols.

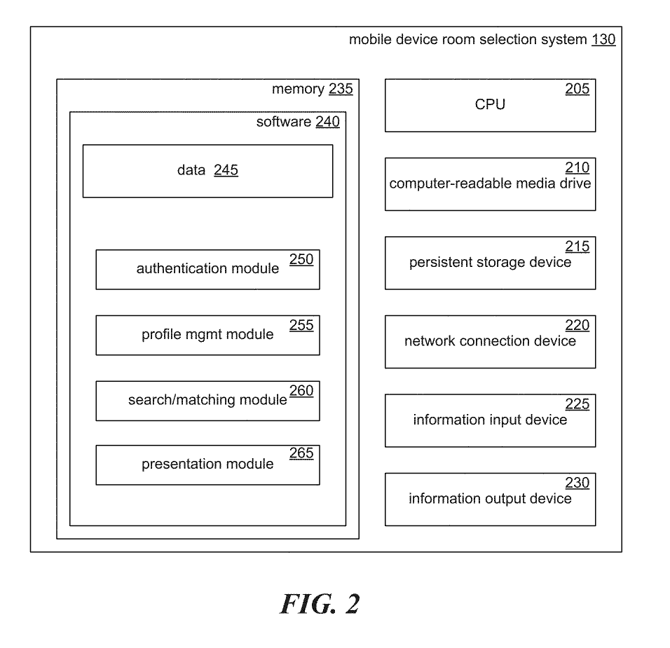

FIG. 2 is an exemplary block diagram illustrating an embodiment of the elements of the system of FIG. 1 in more detail. As shown in FIG. 2, the mobile device room selection system 130 includes one or more central processing units (CPU) 205 for executing software 240, a computer-readable media drive 210 for reading information or installing software 240 from tangible computer-readable storage media (e.g., CD-ROM, a DVD, a USB flash drive and/or other tangible computer readable storage media), a network connection device 220 for connecting to a network, an information input device 225 (e.g., mouse, keyboard), an information output device 230 (e.g., display), and a memory 235.

The memory 235 stores software 240, which incorporates data 245, which may be partially or wholly stored within the mobile device room selection system 130. In some embodiments, the data 245 may reside externally and may be communicatively coupled to software 240. The software 240 performs certain methods or functions described herein, and may include components, subcomponents, or other logical entities that assist with or enable the performance of some or all of these methods or functions. In the embodiment of FIG. 2, the software 240 is shown to include an authentication module 250, a profile management module 255, a search/matching module 260, and a presentation module 265, each of which will be described in more detail below.

The authentication module 250 may comprise any combination of software agents and/or hardware components able to receive login credentials from a customer (e.g., a customer name, e-mail address, or loyalty status number, and a password or biometric information corresponding to the customer), and grant or deny access to the mobile device room selection system 130 based on the received credentials. Similarly, the authentication module 250 may comprise any combination of software agents and/or hardware components able to receive login credentials from an agent or administrator employed by or operating on behalf of a hotel property, and grant or deny the agent or administrator access to the mobile device room selection system 130.

The profile management module 255 may be any combination of software agents and/or hardware components that update various profiles used by the mobile device room selection system 130. The profile management module 255 maintains and makes use of multiple profiles, including for example customer profiles that store information pertaining to individual customers of the hotel property, a hotel property profile that stores information pertaining to the hotel property as a whole, and room profiles that store information pertaining to characteristics and amenities associated with a particular room within the hotel property. For example, the profile management module is adapted to allow a customer to edit or view certain customer profile information, such as basic information (e.g., name, date of birth, gender, occupation, addresses, and telephone numbers), billing information (e.g., credit card numbers, security code, billing address, expiration date), and preferences (e.g., proximity to certain features or amenities, preferred floors, preferred views, preferred room attributes such as bed size and handicap accessibility, and preferred availability of room service or airport shuttle service). In addition, the profile management module 255 is adapted to allow hotel property agents 150A-150M or an administrator 160 to edit or view certain customer profile information, some of which may not be visible to the customer(e.g., the customer's history of damage or infractions to hotel property or guests, the customer's year-to-date or lifetime number of stays in the hotel property, or the customer's total amount of money spent at the hotel property.

Similarly, the profile management module 255 is adapted to allow hotel property agents or an administrator to enter and maintain information stored in a hotel property profile (e.g., physical layout of guest rooms and amenities, attributes such as the availability of room service or turndown service, or dispersion preferences such as a desire of hotel property management to optimize heating/cooling efficiency, housekeeping efficiency, or to cluster together or separate certain groups of customers in the hotel).

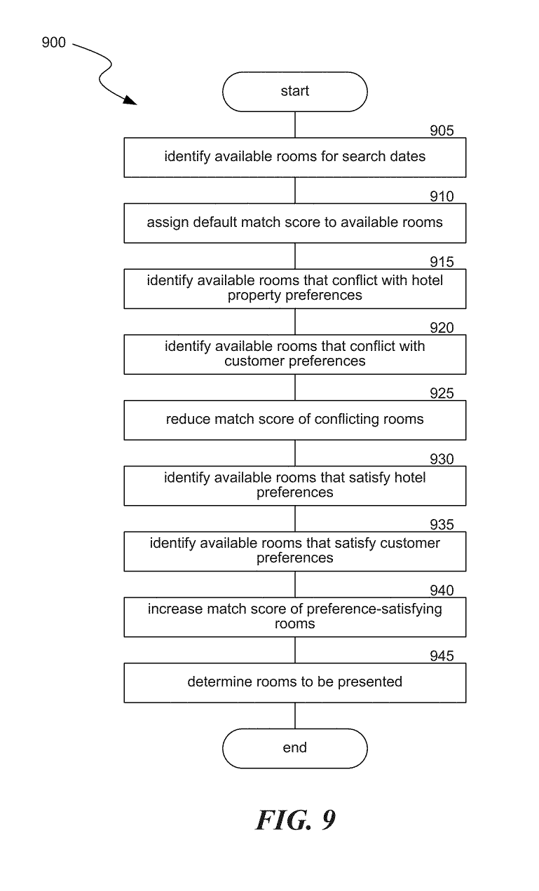

The searching/matching module 260 may comprise any combination of software agents and/or hardware components able to receive a search query from a customer, retrieve applicable profile information (e.g., a customer profile, a hotel property profile, and/or one or more individual room profiles), and determine one or more matching rooms that may be offered to the customer for booking. The searching/matching algorithm may determine matches based on a variety of factors. For example, the searching/matching algorithm may establish a default match score for each available room. For a room that conflicts with one or more customer preferences or one or more hotel property preferences, the searching/matching module may decrease the match score for the room. Similarly, for a room that complies with one or more customer preferences or one or more hotel property preferences, the searching/matching module may increase the match score for the room. The searching/matching module may employ any number of additional or alternative criteria, as discussed more fully below with respect to FIG. 9.

The presentation module 265 may comprise any combination of software agents and/or hardware components able to generate visual information for presentation to a customer, agent, or administrator. For example, the presentation module 265 is adapted to generate separate interfaces for allowing a customer, agent, or administrator to authenticate credentials to access the mobile device room selection system 130, view and/or edit customer profile information, view and/or edit hotel property profile information, view and/or edit individual room profile information, search for individual rooms, display search results, and complete a booking of a selected room. In addition, presentation module 265 is adapted to generate a graphical depiction of a hotel property, including a physical layout of the hotel property's amenities (e.g., pool and spa location, stair and elevator locations, and applicable views such as a city view or a mountain view), as well as a physical layout of rooms. With respect to displaying search results, presentation module 265 is adapted to display rooms corresponding to search results while omitting the display of rooms that are not included in the search results. Presentation module 265 is further adapted to display details regarding a room match, including an indication of whether the room matches one or more specific criteria present in a customer profile. Moreover, presentation module 265 is adapted to alter the physical appearance of rooms appearing in the search results based on the determined strength of the room match and is further adapted to display a legend corresponding to the appearance of the matched rooms on the display. For example, presentation module 265 may display the strongest room matches in a solid pattern (or in a color such as green), may display less strong matches in a striped pattern (or in a color such as yellow), and may display weakest matches in a dotted pattern (or in a color such as red). A person of ordinary skill in the art will appreciate that presentation module 265 may be adapted to highlight differences in match strength using a variety of means, including display of the computed match score, display of any number of different colors or patterns, or shapes, and/or the presentation of audible sounds or haptic feedback.

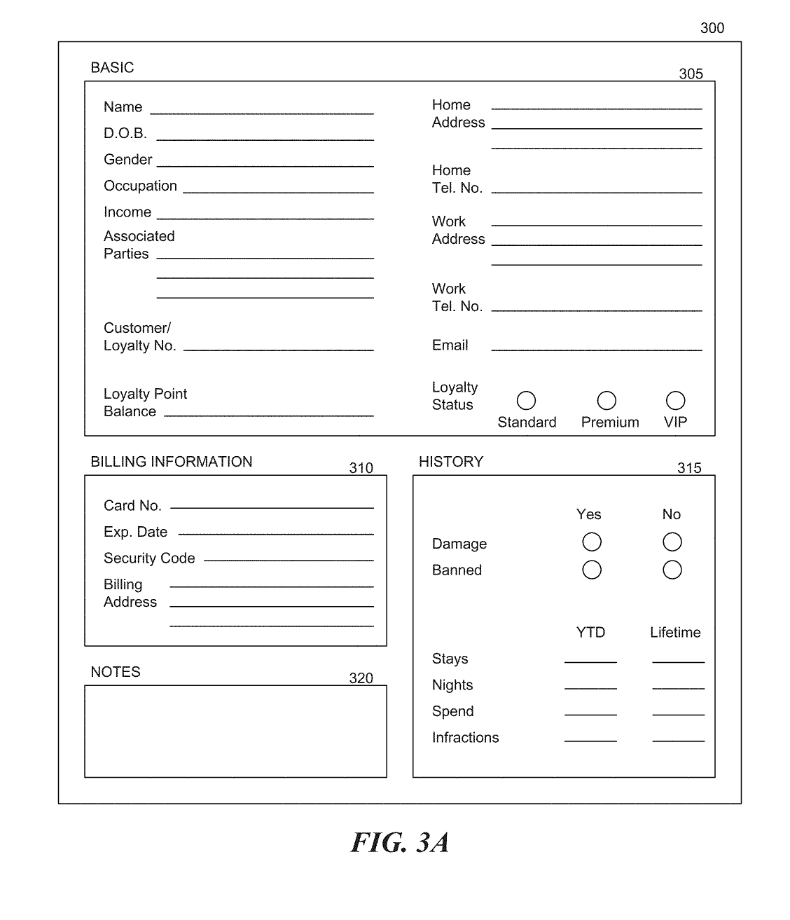

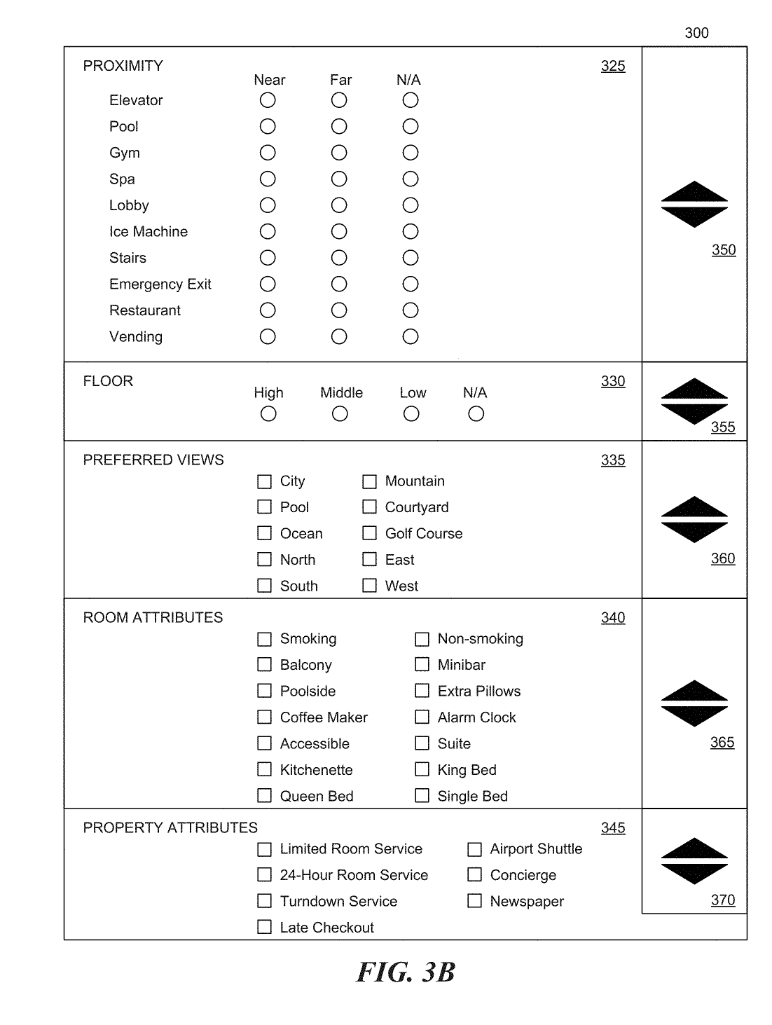

FIG. 3A is a graphical depiction of a background portion of an example customer profile 300 in accordance with embodiments disclosed herein. The mobile device room selection system 130 maintains a separate profile for each customer comprising information provided by the customer, information provided by an agent or administrator of a hotel property, or any combination thereof. The mobile device room selection system 130 is adapted to update and/or supplement information contained in the customer profile 300 when a customer has contact with a hotel property, such as when a customer inquires about a hotel property or room, provides feedback from a previous visit to a hotel property, accesses a website or computer application to search for a room at a hotel property, or completes a booking of a room. The mobile device room selection system 130 is adapted to allow a customer to view certain information contained in his or her customer profile (e.g., the customer's loyalty status level or payment methods) while restricting the customer from viewing certain other information contained in his or her profile (e.g., a total dollar amount spent at a hotel property, or notes entered in the customer profile by a hotel property agent or administrator).

Section 305 of the customer profile contains basic information, including name, date of birth, gender, occupation, income, associated parties (e.g., a family member, employer, person or entity indicated on a previous reservation associated with the customer), customer number or loyalty program number, loyalty point balance, home address and telephone number, work address and telephone number, email address, and loyalty status level. Section 310 of the customer profile contains billing or financial information for the customer, including credit card number, expiration date, security code, and associated billing address. A person of ordinary skill in the art will appreciate that Section 310 may contain any amount of additional and/or alternative information that may be used to collect payment for a room booking, such as a checking account number or other number that enables an electronic funds transfer. Section 315 of the customer profile contains customer history information, including statistical information such as a number of stays in a hotel property, a number of nights spent in a hotel property, an amount of money spent in a hotel property, and a number of infractions or rules violations incurred by the customer in a hotel property (e.g., smoking in a non-smoking room, creating a noise disturbance, etc.). The statistical information in Section 315 of the customer profile may be expressed in terms of year-to-date values, lifetime values, values over a specified period of time, or any combination thereof. Section 315 also contains an indication of whether a customer has damaged hotel property, and whether the customer has been banned from booking a room in a hotel property. Section 320 of the customer profile contains a notes section that stores manually entered comments regarding the customer. In some embodiments, notes section 320 is editable and/or viewable by a customer, while in other embodiments, notes section 320 is editable and/or viewable only by an agent or administrator of a hotel property. In yet other embodiments, customer profile 300 contains separate notes sections that are editable and/or viewable by the customer or hotel property staff (i.e., agent or administrator), respectively.

FIG. 3B is a graphical depiction of a preferences portion of an example customer profile 300 in accordance with embodiments disclosed herein. Section 325 of the customer profile contains proximity preferences, including whether the customer prefers to be near to, far from, or has no preference regarding proximity to various amenities including an elevator, pool, gym, spa, lobby, ice machine, stairs, emergency exit, restaurant, or vending machine. A person of ordinary skill in the art will appreciate that Section 325 of the customer profile may contain any number of additional and/or alternative proximity preferences, including, for example, a customer's desired proximity to a business center or a tennis court. Section 330 of the customer profile contains floor preferences, including whether the customer prefers to be on a relatively high floor, a relatively low floor, a middle floor, or has no preference regarding floor location. A person of ordinary skill in the art will appreciate that Section 330 of the customer profile may allow a customer to specify any number of additional and/or alternative preferences regarding floor location, such as a specific floor number that is preferable to book or a specific floor number that is preferable to avoid. Section 335 of the customer profile contains view preferences, including whether the customer prefers a view of the city, mountain, pool, courtyard, ocean, or golf course. In addition, Section 335 of the customer profile contains an indication of whether the customer prefers a north-facing view, south-facing view, east-facing view, or west-facing view. A person of ordinary skill in the art will appreciate that Section 335 of the customer profile may allow a customer to specify any number of additional and/or alternative view preferences, including a preference regarding special or seasonal views (e.g., fireworks displays or holiday parades). Section 340 of the customer profile contains room attribute preferences, including, for example, a customer's preference regarding whether smoking is allowed or prohibited; whether the room is located at poolside, is a suite, or is handicap accessible; or whether the room contains a balcony, minibar, extra pillows, a coffee maker, an alarm clock, a kitchenette, a king bed, a queen bed, or a single bed. A person of ordinary skill in the art will appreciate that Section 340 of the customer profile may contain any number of additional and/or alternative attribute preferences, including whether the room contains artwork or furnishings by a particular designer. Section 345 of the customer profile contains hotel property preferences, including, for example, the customer's preference regarding the availability of a late checkout or the availability of room service (e.g., limited room service or 24-hour room service), turndown service, airport shuttle, concierge, or newspaper delivery to the room. A person of ordinary skill in the art will appreciate that Section 345 of the customer profile may allow a customer to specify any number of additional and/or alternative hotel property attributes, such as an availability of an on-site tennis professional or a personal butler.

One or more sections of the example customer profile 300 may contain priority indicators that allow the customer to assign a relative priority to certain sections of the customer profile. For example, proximity section 325 contains priority indicator 350, floor section 330 contains priority indicator 355, preferred view section 335 contains priority indicator 360, room attribute section 340 contains priority indicator 365, and property attribute section 345 contains priority indicator 370. The mobile device room selection system 130 enables a customer to manipulate each priority indicator to set a priority of a respective customer profile section relative to another customer profile section. For example, customer profile 300 depicts preferred view section 335 in a higher position than room attribute section 340, and therefore the customer's preferences regarding view will take priority over the customer's preferences regarding room attributes. Accordingly, as a practical example, the depicted customer profile 300 may indicate that the customer prefers an east-facing view and a king bed. In accordance with the priority indicators 360 and 365, the mobile device room selection system 130 would tend to indicate a stronger match for a room having an east-facing view relative to a room having a king bed. However, the mobile device room selection system 130 enables a customer to change the priority of a given preference section by adjusting the respective priority indicator. In the previous example, the user may click the up arrow of priority indicator 365 to prioritize room attributes over preferred views (or, alternatively, the user may click the down arrow of priority indicator 360 to de-prioritize preferred views with respect to room attributes). After making such an adjustment, the mobile device room selection system 130 would now tend to indicate a stronger match for the room having a king bed relative to the room having an east-facing view.

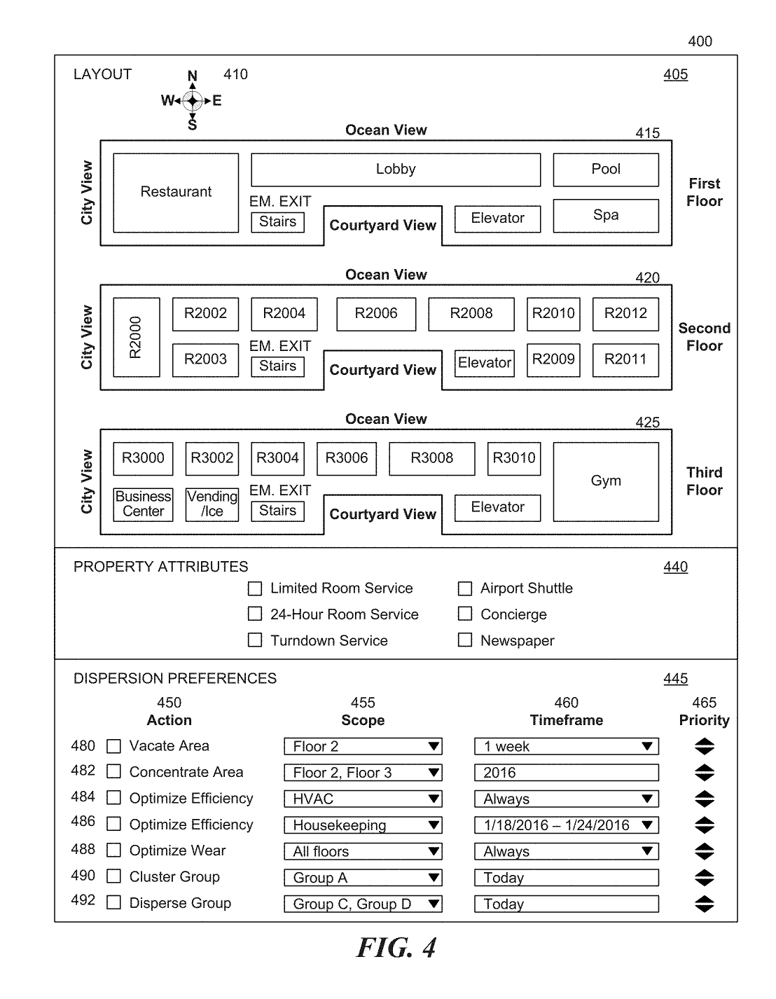

FIG. 4 is a graphical depiction of an example hotel property profile 400 in accordance with embodiments disclosed herein. The mobile device room selection system 130 maintains a separate profile for each separate hotel property comprising information typically provided by an owner, designer, construction contractor, agent, or administrator of a hotel property, or any combination thereof. The mobile device room selection system 130 is adapted to update and/or supplement information contained in the hotel property profile 400 in a dynamic fashion, such as when a customer completes a booking of a room, or when features or amenities are added to or removed from the hotel property (e.g., the installation of a new swimming pool or the removal of a vending machine). The mobile device room selection system 130 is adapted to allow a customer to view certain information contained in the hotel property profile (e.g., available amenities and views) while restricting the customer from viewing certain other information contained the hotel property profile (e.g., dispersion preferences, as discussed in more detail below).

Section 405 of the hotel property profile contains a graphical layout of the hotel property. Section 405 of the hotel property profile depicts first floor 415, which comprises a restaurant, lobby, pool, spa, stairs (which may function as an emergency exit) and elevator; second floor 420, which comprises multiple guest rooms as well as emergency exit stairs and an elevator; and third floor 425, which comprises multiple rooms, emergency exit stairs, elevator, business center, vending machine, ice machine, and gym. In addition, the depiction of each floor 415, 420, and 425 contains an indication of additional amenities (e.g., ocean view, courtyard view, and city view) in a manner that readily conveys which of certain amenities are associated with each room. For example, first floor 415 depicts a lobby having an ocean view, second floor 420 depicts the location of room R2004 in close proximity (i.e., directly across the hall) from emergency exit stairs, third floor 425 depicts guest room R3000 as having both a city view and an ocean view, and so on. Moreover, compass 410 enables a ready indication of which rooms and amenities of the hotel property contain views in any given cardinal direction. As a result of the hotel property layout depicted in section 405 of the hotel property profile, a customer or hotel property agent or administrator is able to readily identify or verify rooms that comply with certain indicated preferences or conflict with certain indicated preferences. Although layout section 405 of the hotel property profile depicts only three floors and a limited number of amenities and rooms, a person of ordinary skill will appreciate that any number of floors, rooms, or amenities may be depicted in the mobile device room selection system 130. The system is adapted for use in hotel properties of any size, including for example large hotel properties such as casinos that may contain in excess of one hundred floors and thousands of individual rooms.

Section 440 of the hotel property profile contains attributes of the hotel property, including, for example the availability of room service (e.g., limited room service or 24-hour room service), turndown service, airport shuttle, concierge, or newspaper delivery to the room. A person of ordinary skill in the art will appreciate that section 440 of the hotel property profile may account for any number of additional and/or alternative hotel property attributes.

Section 445 of the hotel property profile contains dispersion preferences for the hotel property. A dispersion preference allow a hotel property agent or administrator to control the manner in which rooms tend to be allocated to customers throughout the hotel property. Section 445 of the hotel property profile specifies example dispersion preferences 480-492. Each dispersion preference is specified using one or more parameters. For example, each of dispersion preferences 480-492 is specified in terms of action 450, scope 455, timeframe 460, and priority 465. Actions 450 correspond to a hotel property agent or administrator's goals for a given dispersion preference, such as optimizing efficiency of heating, ventilation, and air conditioning (HVAC) equipment or optimizing wear on furniture or equipment present in a room. Scope 455 corresponds to the breadth of the action 450. For example, scope 455 may correspond to whether an action 450 should be taken with respect to a particular room or group of rooms, a particular floor or group of floors, one or more particular clusters of customers, and so on. Timeframe 460 corresponds to a duration for which the action 450 should remain in effect. For example, a timeframe 460 may correspond to whether the action 450 should remain in effect for a relatively short period of time (e.g., for the present day only), a longer period of time (e.g., two weeks, one month, or a particular date range such as January 1-March 31), or indefinitely (i.e., until a hotel property agent or administrator cancels or removes the dispersion preference). Priority 465 corresponds to the relative importance of each dispersion preference in section 445 relative to other dispersion preferences. Dispersion preferences having a higher priority are enforced before dispersion preferences having a lower priority, and, in the event that two or more dispersion preferences stand in conflict, the mobile device room selection system enforces the dispersion preference with the highest priority. For example, a first dispersion preference to vacate the second floor of a hotel property and a second dispersion preference to optimize wear on all floors of the hotel property may generate a conflict. In this example, the conflict may arise because the mobile device room selection system would tend to allocate rooms on the second floor in order to maintain even wear and tear (in accordance with the second dispersion preference). However, the system also would tend to allocate rooms in a manner that vacates the second floor (in accordance with the first dispersion preference). If the second dispersion preference to vacate is set at a higher priority than the first dispersion to optimize wear, the mobile device room selection system will enforce the higher priority. Therefore, the system would tend to vacate the second floor, even if doing so causes rooms in the hotel property to wear unevenly. A hotel agent or administrator may edit a priority of a given dispersion preference by adjusting the priority selector 465 to increase or decrease the priority of a given dispersion preference relative to other dispersion preferences.

As practical examples, dispersion preferences 480-492 illustrate how a hotel property agent or administrator may directly affect a manner in which rooms tend to be allocated to customers. Dispersion preference 480 specifies that the mobile device room selection system 130 should allocate rooms in a manner that tends to vacate the second floor of the hotel property for a period of one week. Accordingly, dispersion preference 480 could be useful to a hotel property agent or administrator in circumstances where, for example, a particular floor is undergoing a major construction or renovation project. Dispersion preference 482 specifies that the mobile device room selection system should concentrate customers on the second and third floors of the hotel property for the entire year of 2016. Accordingly, dispersion preference 482 may be useful in circumstances where, for example, hotel property agents or administrators intend to showcase an area of a hotel property that has recently undergone a major renovation. Dispersion preferences 484 and 486 allow an administrator or agent to specify that the mobile device room selection system should optimize the efficiency of the hotel property's operations. In particular, dispersion preference 484 specifies that rooms should be allocated in a manner that tends to optimize efficiency of HVAC units in the hotel property for an indefinite time period (i.e., until a hotel agent or administrator specifies otherwise). HVAC optimization may comprise allocating rooms in portions of the hotel property that are served by newer HVAC units, or may comprise clustering customers in certain rooms in order to minimize a number of HVAC units that are in operation at any given time. Dispersion preference 486 specifies allocating rooms in a manner that tends to optimize housekeeping services within the hotel property for the period of Jan. 18 through Jan. 24, 2016. Housekeeping optimization may comprise clustering customers in certain rooms in order to minimize a number of cleaning staff needed to service rooms, or clustering customers in certain rooms in order to minimize an overall amount of time needed to service rooms.

Dispersion preference 488 specifies that the mobile device room selection system should allocate rooms in a manner that tends to optimize wear among all floors in the hotel property on a permanent or indefinite basis (i.e., until a hotel agent or administrator specifies otherwise). Optimizing wear throughout the hotel property may help ensure that various components of the hotel property's rooms (e.g., bedding, carpet, furniture, bathroom fixtures, etc.) wear at an even rate. Accordingly, dispersion preference 488 may enable hotel property agents and administrators to upgrade room components on a more predictable basis, thereby allowing for better planning of operating costs and capital expenditures. Dispersion preferences 490 and 492 specify that the mobile device room selection system should allocate rooms in a manner that tends to cluster certain groups of customers and separate certain other groups of customers. For example, dispersion preference 490 specifies that the mobile device selection system should for today only allocate rooms in a manner that tends to place customers belonging to Group A (e.g., attendees of an airline pilot convention) in rooms that are physically close to other customers belonging to the same group. Dispersion preference 492 specifies that the mobile device selection system should for today only allocate rooms in a manner that tends to place customers belonging to Group C (e.g., a girls soccer team) in rooms that are physically distant to customers belonging to Group D (e.g., boys soccer team).

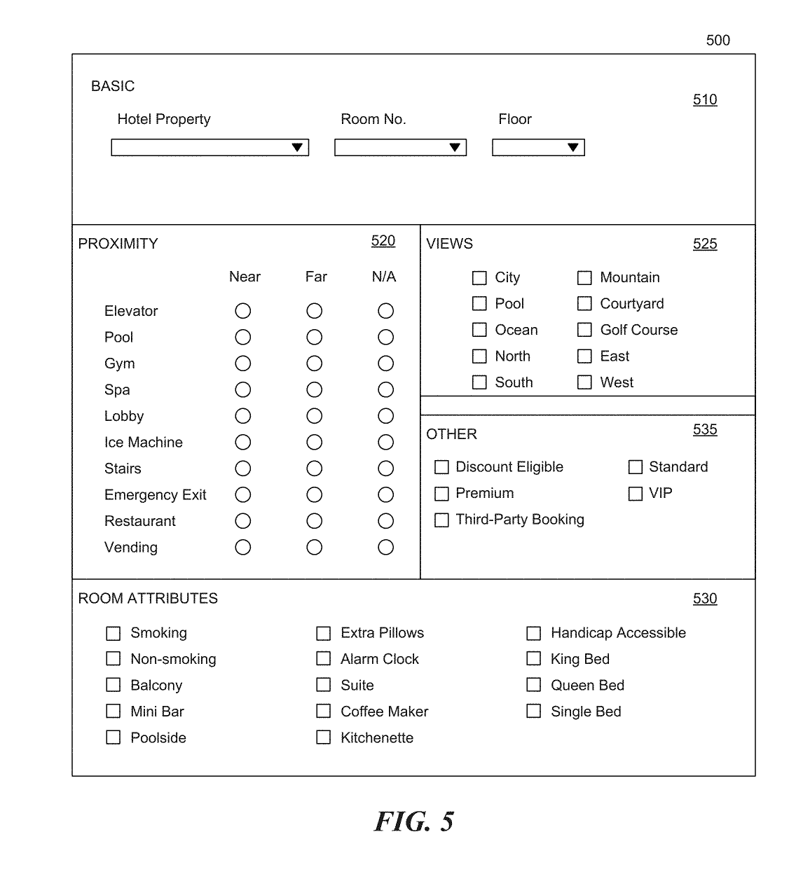

FIG. 5 is a graphical depiction of an example room profile 500 in accordance with embodiments disclosed herein. For each room in a hotel property, the mobile device room selection system 130 maintains a separate profile comprising information typically provided by an owner, designer, construction contractor, agent, or administrator of a hotel property, or any combination thereof. The mobile device room selection system 130 is adapted to update and/or supplement information contained in the room profile 500 in dynamic fashion, such as when a customer completes a booking of a room, or when features or amenities are added to or removed from a room (e.g., the installation of a new kitchenette or the removal of a coffee maker). The mobile device room selection system 130 is adapted to allow a customer to view certain information contained in the room profile (e.g., available amenities and views) while restricting the customer from viewing certain other information contained the hotel property profile (e.g., discount eligibility of the room).

Section 510 of the room profile contains basic information, including the name of the hotel property in which the room is located, the room number, and the floor on which the room is located. Section 520 of the room profile contains proximity attributes of the room, including whether the room is near to, far from, or is neither near to nor far from various amenities in the associated hotel property such as an elevator, pool, gym, spa, lobby, ice machine, stairs, emergency exit, restaurant, or vending machine. A person of ordinary skill in the art will appreciate that Section 520 of the room profile may contain any number of additional and/or alternative proximity attributes, including, for example, the room's proximity to a business center or a tennis court. Section 525 of the room profile contains view attributes, including whether the room is associated with a view of a city, mountain, pool, courtyard, ocean, or golf course. In addition, Section 525 of the room profile contains an indication of whether the room is associated with a north-facing view, south-facing view, east-facing view, or west-facing view. A person of ordinary skill in the art will appreciate that Section 525 of the room profile may indicate any number of additional and/or alternative view attributes, including special or seasonal views (e.g., fireworks displays or holiday parades). Section 530 of the room profile contains room attributes, including, for example, an indication of whether smoking is allowed or prohibited in the room; whether the room is located at poolside, is a suite, or is handicap accessible; or whether the room contains a balcony, minibar, extra pillows, a coffee maker, an alarm clock, a kitchenette, a king bed, a queen bed, or a single bed. A person of ordinary skill in the art will appreciate that section 530 of the room profile may contain any number of additional and/or alternative attributes, including whether the room contains artwork or furnishings by a particular designer. Section 535 of the room profile contains additional room attributes, including, for example, whether the room is available to customers who book the room at a discount, book the room through a third party, hold standard loyalty status (or no loyalty status), hold premium (or enhanced) loyalty status, or hold VIP (or a highest attainable level of) loyalty status. A person of ordinary skill in the art will appreciate that Section 535 of the room profile may specify any number of additional and/or alternative room attributes, such as whether the room contains a video game console or large screen television.

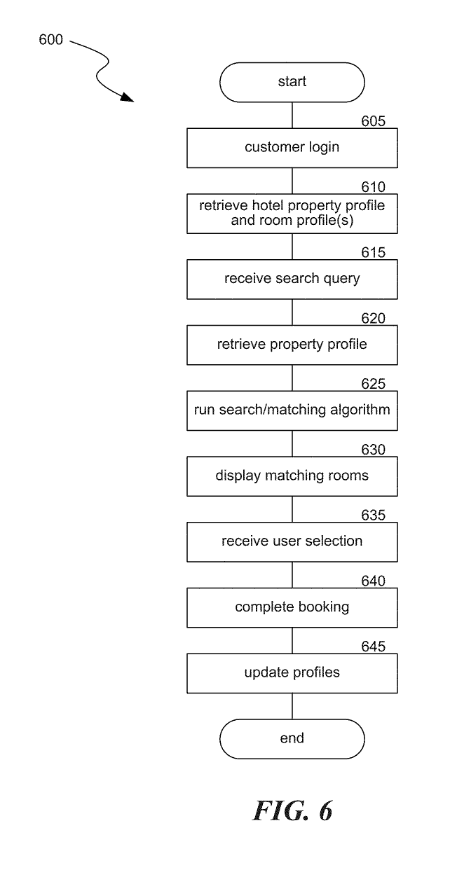

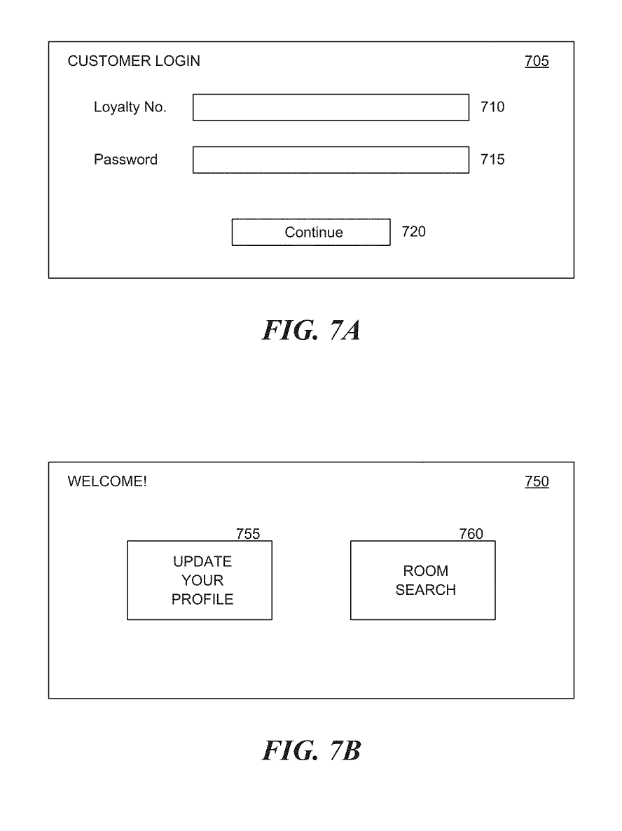

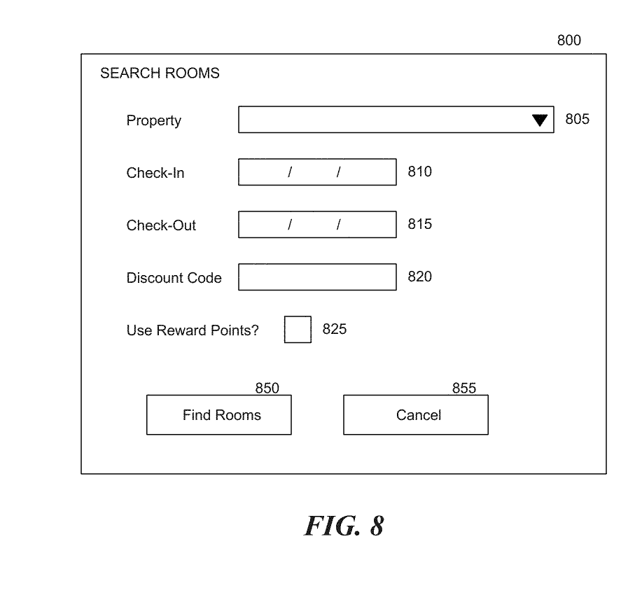

FIG. 6 is a flowchart 600 showing a method implemented by the mobile device room selection system to enable a customer to search for and book a hotel room in accordance with embodiments herein. At step 605, a customer enters a user name and password to authenticate to the mobile device room selection system. Alternatively, the customer may authenticate to the mobile device room selection system by providing biometric information via a mobile device, or by using a previously stored user name and password such that the user is authenticated automatically. FIG. 7A is a graphical depiction of an example customer login screen 705 in accordance with embodiments disclosed herein. Customer login screen 705 comprises an input field 710 to receive a customer identifier (e.g., a loyalty program number or an e-mail address), a password field 715 to receive a customer password (or, alternatively, a request to authenticate by providing biometric information via the customer's mobile device), and a continue button 720 that when clicked causes the mobile device room selection system to verify the customer's login credentials. If the mobile device room selection system successfully authenticates the customer, the system displays a customer welcome screen. FIG. 7B is a graphical depiction of an example customer welcome screen 750 in accordance with embodiments disclosed herein. Customer welcome screen 750 comprises a button 755 that when clicked causes the mobile device room selection system to allow the customer to manually update at least a portion of the customer's profile, including customer preferences. Customer welcome screen 750 also comprises a button 760 that when clicked presents a room search screen (discussed in more detail below with respect to FIG. 8) that allows the customer to search for a room. Returning to FIG. 6, at step 610, the mobile device room selection system retrieves the customer's profile information. At step 615, the mobile device room selection system receives a search query from the customer to identify one or more rooms that are available for booking. The search query is received via a graphical interface that is presented to the customer. For example, the customer may click room search button 760 on welcome screen 750 of FIG. 7B to cause the mobile device room selection system to present the customer with a search interface.

FIG. 8 is a graphical depiction of an example search interface screen 800 in accordance with embodiments disclosed herein. Search interface 800 enables the customer to formulate a search by populating one or more fields containing search criteria, including property field 805 (which may contain a drop-down list of one or more hotel properties or one or more desired cities in which hotel properties are located), check-in field 810 (which corresponds to a day that the customer wishes to check into a hotel property), check-out field 815 (which corresponds to a day that the customer wishes to check out of a hotel property), discount code 820 (which allows the customer to enter a code to redeem a discount, such as an organizational or senior citizen discount), and rewards point checkbox 825 (which allows the customer to redeem accrued loyalty points as full or partial payment for a hotel room). After the customer enters search criteria in one or more of search fields 805-825, the customer may click button 850 to execute the search. Alternatively, the customer may click button 855 to cancel the search. Returning to FIG. 6, in response to the customer submitting a search query, the mobile device room selection system at step 620 retrieves a hotel property profile and/or one or more room profiles. At step 625, the mobile device room selection system runs a search/matching algorithm to determine one or more matching rooms to present to the customer for selection and booking.

FIG. 9 is a flowchart 900 showing a method implemented by the mobile device room selection system to run a search/matching algorithm in accordance with embodiments herein. At step 905, the system identifies rooms that are available (i.e., not already booked) in a requested hotel property during a requested time period as specified in a customer search query. At step 910, the system assigns a default match score to each of the available rooms. A match score provides an indication of the degree to which an individual room satisfies a customer's search query as well as preferences provided by the customer and/or a hotel property administrator or agent. The match score may be expressed in numerical terms, such as a raw number or a percentage, although a person of ordinary skill in the art will appreciate that the match score may be represented by any means that allows the system, a customer, or a hotel agent or administrator to appreciate differences in match quality among multiple rooms. At step 915, the system uses information stored in the customer profile, hotel property profile, and/or individual room profiles to identify rooms that conflict with one or more hotel property preferences (e.g., allocating a VIP room to a customer with a standard loyalty status may create a conflict). Similarly, at step 920, the system uses information stored in the customer profile, hotel property profile, and/or individual room profiles to identify rooms that conflict with one or more customer preferences (e.g., allocating a room that is not handicap accessible to a customer who requires an accessible room may create a conflict). At step 925, the system reduces the default match score for rooms determined to conflict with hotel property preferences or customer preferences. In some embodiments, the system reduces the default match score in proportion to the number or severity of the determined conflicts. In some embodiments, the system may reduce the default match score by varying amounts. For example, the system may impose a more severe match score reduction for a hotel property profile conflict as compared to a customer profile conflict, or vice versa. Moreover, the system may impose a more severe or less severe match score reduction based on the particular conflict (e.g., a conflict arising from a HVAC efficiency dispersion preference may result in a more severe match score reduction than a conflict arising from a customer's preference to be located near an ice machine).

At step 930, the system uses information stored in the customer profile, hotel property profile, and/or individual room profiles to identify rooms that comply with one or more hotel property preferences (e.g., allocating a third-floor room may comply with a dispersion preference to vacate the second floor). Similarly, at step 935, the system uses information stored in the customer profile, hotel property profile, and/or individual room profiles to identify rooms that comply with one or more customer preferences (e.g., allocating an accessible room to a customer with a physical impairment may comply with the customer's preferences). At step 940, the system increases the default match score for rooms determined to comply with hotel property preferences or customer preferences. In some embodiments, the system increases the default match score in proportion to the number or importance of the determined compliances. In some embodiments, the system may increase the default match score by varying amounts. For example, the system may grant a more generous match score increase for a hotel property profile compliance as compared to a customer profile compliance, or vice versa. Moreover, the system may grant a more generous or less generous match score increase based on the particular compliance (e.g., complying with a customer's smoking preference may result in a more generous match score increase than complying with a hotel property's preference cluster together certain groups of customers).

At step 945, the system determines one or more matching rooms to be presented to the customer for review and potential booking. The system may use any number of criteria to determine which matching rooms to present to the customer. For example, the system may present a predetermined or user-specified number of rooms corresponding to the highest match scores. As another example, the system may present all matching rooms that meet or exceed a predetermined or user-specified raw match score or match score percentile. In some embodiments, the system may impose additional and/or alternative criteria to determine one or more matching rooms to be presented to the customer. For example, the system may limit presented matches to rooms that comply with a specified number or percentage of customer preferences, comply with a specified number or percentage of hotel property preferences, comply with one or more specific customer preferences or hotel property preferences, do not conflict with more than a specified number or percentage of customer preferences, do not conflict with more than a specified number or percentage of hotel property preferences, or do not conflict with more one or more specific customer preferences or hotel property preferences.

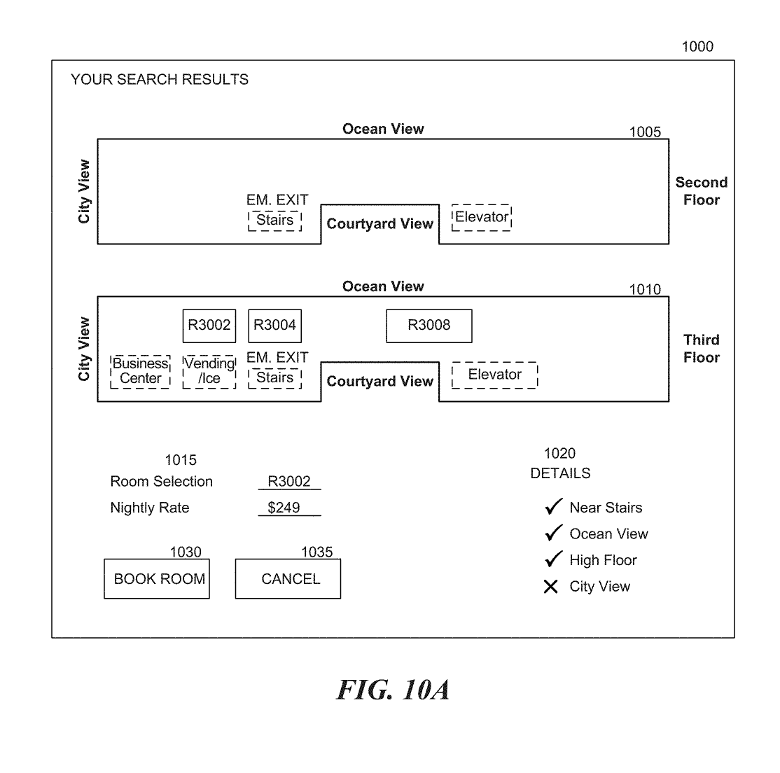

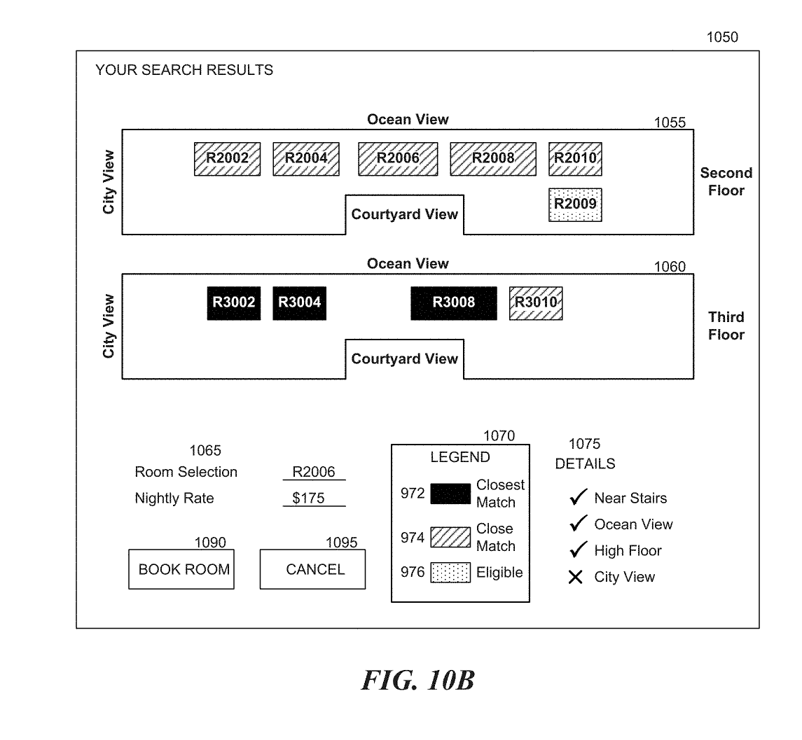

Returning to FIG. 6, at step 630, the mobile device room selection system presents a search result interface to the customer in order to display matching rooms for selection and booking. FIG. 10A is a graphical depiction of a first embodiment of a search results interface 1000 as disclosed herein. The search results interface 1000 includes a depiction of second floor 1005 and third floor 1010 of the hotel property. The depiction of second floor 1005 does not indicate any preferred room matches on the second floor, although the depiction 1005 does include certain amenities and features of the hotel property for reference purposes. The depiction of third floor 1010 indicates three room matches (i.e., rooms R3002, R3004, and R3008), as well as various amenities such as a business center, vending machine, ice machine, emergency exit stairs, and elevator.

The search results interface 1000 assists the customer in room selection by allowing the customer to easily verify that a presented room option is consistent with the customer's preferences. For example, the customer's profile may indicate that the customer prefers to be located near stairs, on a high floor, and in a room having an ocean view and a city view. In the present example, the system may determine that the closest matches are rooms R3002, R3004, and R3008. Accordingly, search results interface 1000 depicts a hotel property layout having only those three rooms shown for selection. Note that certain other rooms in the hotel property, whether vacant or occupied, may not be displayed to the customer. In the present example, no rooms on the second floor are displayed because the customer's profile indicates that the customer prefers a room on a high floor. Similarly, room R3010 is not shown because the customer's profile indicates that the customer prefers to be located near a stairwell. In addition, certain rooms may not be displayed because the room is booked to another customer, because allocation of the room conflicts with the hotel property's dispersion preferences, because the room is not eligible for a discount that the customer intends to use, or because the room requires a higher loyalty status level than the customer has attained. Search results interface 1000 shows details 1020 for a selected room. For example, as indicated by room selection “R3002” in section 1015, details section 1020 indicates that selected room R3002 is near stairs, has an ocean view, and is located on a relatively high floor, but lacks a city view. In addition, section 1015 of the search results interface displays a nightly rate for the selected room. The customer may click button 1030 to book the selected room, or the customer may click button 1035 to cancel the search without booking a room.

FIG. 10B is a graphical depiction of a second embodiment of a search results interface as disclosed herein. Search results interface 1050 differs from search results interface 1000 primarily in that interface 1050 includes a larger number of search results that are organized by match strength. To distinguish among rooms having stronger or weaker matches to a customer's search query and/or profile preferences, search results interface 1050 includes a legend 1070 that indicates match strength. For example, rooms having a solid pattern represent the strongest matches, rooms having a diagonal stripe represent matches that are not as strong as the strongest matches, and rooms having a dotted pattern represent the weakest matches among the displayed rooms. Using the previous example, rooms R3002, R3004, and R3008 remain in the search results because those rooms are located near stairs, are located on a relatively high floor (i.e., third floor 1060), and have an ocean view, as indicated as preferable in the customer's profile. In search results interface 1050, however, the search results depict rooms R3002, R3004, and R3008 in a solid color because those rooms most closely match the customer's criteria. The search result interface 1050 also shows six additional rooms (i.e., R2002, R2004, R2006, R2008, R2010, and R3010) having diagonal stripes to indicate a match that is weaker than the rooms presented in a solid pattern. For example, although guest rooms R2002, R2004, R2006, R2008, R2010 have an ocean view, those rooms are located on second floor 1055 rather than on the highest floor. Additionally, guest rooms R2008 and R2009 are not particularly close to the stairs, which is another attribute that the customer profile indicates as preferable. For at least these reasons, rooms R2002, R2004, R2006, R2008, R2010, and R3010 are displayed as a weaker match (i.e., diagonal stripes) rather than a strongest match (i.e., solid pattern). In addition, room R2009 is shown in a dotted pattern that indicates that the room is a yet weaker match because room R2009 is not near stairs, does not have an ocean view, is not on a high floor, and does not have a city view. Despite these shortcomings, room R2009 may be displayed because allocating the room to the customer may not directly contradict an unacceptable number of hotel property preferences (such as dispersion preferences) or customer profile preferences (such as handicap accessibility). As before, search result interface 1050 shows details 1075 for a selected room. For example, as indicated by room selection “R2006” in section 1065, details section 1075 indicates that selected room R2006 is near stairs and has an ocean view, but lacks a high floor and a city view. In addition, section 1065 of the search results interface displays a nightly rate for the selected room. The customer may click button 1090 to book the selected room, or may click button 1095 cancel the search without booking a room.

Returning to FIG. 6, at step 635 the system receives a customer selection of a room, and at step 640, the system completes a room booking in response to receiving a request from a customer to book the selected room. After booking, at step 645, the mobile device room selection system 130 updates various profile information used by the system. For example, the mobile device room selection system may update customer profile information to accurately reflect a number of stays, a number of nights, and an amount of spend for the customer, as well as any change in loyalty status level that results from the booking. The system also may update the profile for the booked room to reflect that the room is booked (and therefore unavailable to other customers) during the requested period, and to enable the system to make appropriate future bookings in accordance with hotel property profile preferences, such as dispersion and wear preferences.

From the foregoing, it will be appreciated that specific embodiments of the invention have been described herein for purposes of illustration, but that various modifications may be made without deviating from the scope of the invention. Those skilled in the art will appreciate that the operations and routines depicted in flowchart blocks and otherwise described herein may be altered in a variety of ways. More specifically, the order of the steps may be re-arranged, steps may be performed in parallel, steps may be omitted, other steps may be included, various combinations or omissions of routines may be made, etc. Accordingly, the invention is not limited except as by the appended claims.

I/we claim:

1. A method in a computing system for searching for rooms in response to receiving a query from a mobile device, the method comprising:
providing a room search interface to a mobile device;
receiving a search query via the room search interface, wherein the search query includes at least an indication of a desired timeframe and an indication of a desired hotel property or a desired location of a hotel property;
retrieving profile information, wherein the retrieved profile information comprises one or more preferences or attributes associated with a user of the mobile device, the desired hotel property, or a hotel property at the desired location;
computing a match score for one or more rooms associated with the desired hotel property or hotel property at the desired location, wherein the computation comprises decreasing the match score in response to a determination that the room conflicts with one or more of the preferences or attributes, or increasing the match score in response to a determination that the room complies with one or more of the preferences or attributes; and
providing a search results interface to the mobile device, the search results interface including one or more rooms having a match score that satisfy at least one predetermined criterion.

2. The method of claim 1, wherein at least one predetermined criterion is that (a) the room does not conflict with more than a specified number of hotel property preferences, (b) the room does not conflict with more than a specified number of customer preferences, (c) the room complies with at least a specified number of hotel property preferences, (b) the room complies with at least a specified number of customer preferences, or (e) the computed match score for the room meets or exceeds a specified value.

3. The method of claim 1, wherein retrieving profile information comprises retrieving information from a customer profile, a hotel property profile, and/or a room profile.

4. The method of claim 1, wherein the retrieved profile information includes one or more priority indications corresponding to one or more of the preferences or attributes.

5. The method of claim 1, wherein the search results interface contains an indication of the match score for the one or more rooms.

6. The method of claim 1, further comprising authenticating the mobile device prior to providing the room search interface, the authentication based at least on one or more received credentials of the user of the mobile device.

7. The method of claim 1, wherein the search results interface provides details of an identified room, the details including an indication of whether or not the identified room complies with or conflicts with one or more specific preferences of the user of the mobile device.

8. A computer-readable storage medium with instructions stored thereon that, when executed by a computing system, cause the computing system to perform a method for searching for rooms in response to receiving a query from a mobile device, the method comprising:
providing a room search interface to a mobile device;
receiving a search query via the room search interface, wherein the search query includes at least an indication of a desired timeframe and an indication of a desired hotel property or a desired location of a hotel property;
retrieving profile information, wherein the retrieved profile information comprises one or more preferences or attributes associated with a user of the mobile device, the desired hotel property, or a hotel property at the desired location;
computing a match score for one or more rooms associated with the desired hotel property or hotel property at the desired location, wherein the computation comprises decreasing the match score in response to a determination that the room conflicts with one or more of the preferences or attributes, or increasing the match score in response to a determination that the room complies with one or more of the preferences or attributes; and
providing a search results interface to the mobile device, the search results interface including one or more rooms having a match score that satisfy at least one predetermined criterion.

9. The computer-readable storage medium of claim 8, wherein at least one predetermined criterion is that (a) the room does not conflict with more than a specified number of hotel property preferences, (b) the room does not conflict with more than a specified number of customer preferences, (c) the room complies with at least a specified number of hotel property preferences, (b) the room complies with at least a specified number of customer preferences, or (e) the computed match score for the room meets or exceeds a specified value.

10. The computer-readable storage medium of claim 8, wherein retrieving profile information comprises retrieving information from a customer profile, a hotel property profile, and/or a room profile.

11. The computer-readable storage medium of claim 8, wherein the retrieved profile information includes one or more priority indications corresponding to one or more of the preferences or attributes.

12. The computer-readable storage medium of claim 8, wherein the search results interface contains an indication of the match score for the one or more rooms.

13. The computer-readable storage medium of claim 8, further comprising authenticating the mobile device prior to providing the room search interface, the authentication based at least on one or more received credentials of the user of the mobile device.

14. The computer-readable storage medium of claim 8, wherein the search results interface provides details of an identified room, the details including an indication of whether or not the identified room complies with or conflicts with one or more specific preferences of the user of the mobile device.

15. A method in a mobile device for generating a search query and selecting a room in a hotel property, the method comprising:
displaying a room search interface to the user of the mobile device;
receiving a search query via the room search interface, wherein the search query includes at least an indication of a desired timeframe and an indication of a desired hotel property or a desired location of a hotel property;
transmitting the received search query to a computing system;
receiving search results from the computing system, wherein the received search results were generated by:
retrieving profile information, wherein the retrieved profile information comprises one or more preferences or attributes associated with the user of the mobile device, the desired hotel property, or a hotel property at the desired location;
computing a match score for one or more rooms associated with the desired hotel property or hotel property at the desired location, wherein the computation comprises decreasing the match score in response to a determination that the room conflicts with one or more of the preferences or attributes, or increasing the match score in response to a determination that the room complies with one or more of the preferences or attributes; and
providing a search results interface to the mobile device, the search results interface including one or more rooms having a match score that satisfy at least one predetermined criterion.

16. The method of claim 15, wherein at least one predetermined criterion is that (a) the room does not conflict with more than a specified number of hotel property preferences, (b) the room does not conflict with more than a specified number of customer preferences, (c) the room complies with at least a specified number of hotel property preferences, (b) the room complies with at least a specified number of customer preferences, or (e) the computed match score for the room meets or exceeds a specified value.

17. The method of claim 15, wherein retrieving profile information comprises retrieving information from a customer profile, a hotel property profile, and/or a room profile.

18. The method of claim 15, wherein the retrieved profile information includes one or more priority indications corresponding to one or more of the preferences or attributes.

19. The method of claim 15, wherein the search results interface contains an indication of the match score for the one or more rooms.

20. The method of claim 15, wherein the search results interface provides details of an identified room, the details including an indication of whether or not the identified room complies with or conflicts with one or more specific preferences of the user of the mobile device.
